(19) United States
(12) Patent Application Publication
(10) Pub. No.: US 2003/0031168 A1
(43) Pub. Date: Feb. 13, 2003

(54) Symmetrical telephony system and method

(75) Inventor: Nicola Scioscia, Trento (IT)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(73) Assignee: GlobespanVirata Incorporated, Red Bank, NJ

(21) Appl. No.: 10/064,709

(22) Filed: Aug. 8, 2002

Related U.S. Application Data
(60) Provisional application No. 60/310,838, filed on Aug. 9, 2001.

(51) Int. Cl. H04L 12/66

(52) U.S. Cl. 370/352; 370/395.1; 379/88.17

(57) ABSTRACT

A system and method for providing symmetrical connectivity between at least two consumer premises equipment (CPE) telecommunications devices is provided. At least two consumer premises equipment telecommunications devices are operatively connected over an asynchronous transfer mode telecommunications network. The at least two consumer premises equipment telecommunications devices are configured to perform local tone generation, local tone detection and decoding, and direct transfer and decoding of dialed digits using channel associated signaling secondary service packets and dialed digit packets to transition between various states. By providing symmetrical connectivity of CPE devices, central office involvement may be eliminated.

### CROSS REFERENCE TO RELATED APPLICATIONS

Priority is claimed based on U.S. Provisional Application No. 60/310,838, filed Aug. 9, 2001, the entirety of which is incorporated by reference herein.

### BACKGROUND OF THE INVENTION

The present invention relates generally to voice communication systems and, more particularly, to systems for transmitting and receiving voice information over packet-switched networks.

For years, the telecommunications industry has examined ways to combine the flexibility and functionality of packet-switched networks primarily used for transmitting data (e.g., the Internet) with the accuracy and speed of conventional circuit based telephone networks (i.e., the Public Switched Telephone Network or PSTN). Conventional telephone systems differ from modern data-based computer networks in several ways. Most importantly however, are the differences in how connections between the sender and the recipient are made.

In conventional telephone systems, when a caller picks up his telephone, an OFFHOOK message is sent from the phone across the PSTN to the user's central office (CO). In response, the CO sends a dialtone back to the user's phone indicated that he is connected and can initiate a call. Next, the caller dials the phone number of the intended recipient and, through the keypad tones or pulses, this information is transmitted to the CO. In response, the CO transmits a RINGING message causing the recipient's phone to ring. If the recipient picks up the phone, the recipient's phone sends an OFFHOOK message to the CO and a dedicated circuit across the PSTN between the caller and the recipient is established, enabling voice traffic to pass between the connected parties in a smooth, seamless manner. Typically, the voice traffic is digitized at the CO and transmitted over the dedicated PSTN circuit using a technology called time division multiplexing (TDM). This dedicated circuit continuously transmits information between the parties at a rate of about 128 kilobits per second (kbps) (64 kbps each way) for the duration of the call. For a five minute telephone call, this equates to the transmission of approximately 4.7 megabytes (MB) of information.

Unfortunately, in most telephone conversations, much of the bandwidth required to enable the transmission of information between the parties is wasted. For example, because people typically do not speak while the other party is speaking, almost half of the available bandwidth is wasted during the call. Similarly, during periods of silence (even milliseconds at a time), no information needs to pass between the parties. However, because of the dedicated, physical circuit between the parties, information is passed regardless of content.

Contrary to conventional telephone systems, most data networks such as the Internet, do not transmit information across dedicated, physical circuits. Rather, information sent between two computers on a network is broken up in a series of small packets. These packets are then routed to the destination and reassembled at the recipient end. Various protocols have been developed for enabling the efficient and accurate transfer of information across computer networks, such as internet protocol (IP), asynchronous transfer mode (ATM), Ethernet, etc. Because computer networks only transmit the information which needs to be relayed, there is little wasted bandwidth.

Because of the rising need for network bandwidth and the continued need to optimize bandwidth which is already available, efforts have been made to reduce the bandwidth cost of voice traffic by routing voice traffic over packet-switched networks. This concept is generally referred to as voice over IP telephony, although various other network protocols may also be employed. In general, the concept of voice over IP telephony requires a seamless experience on the part of the user. That is, conventional telephone systems (referred to as plain old telephone systems or POTS) must be able to utilize the technology in an invisible manner. In practice, similar to conventional PSTN devices, when a POTS device (or analogous customer premises equipment (CPE) telecommunications device) goes off hook, a message is sent to a CO indicating this state. A dialed number is then received by the CO, indicating the recipient's address, and the corresponding voice traffic is digitized and packetized at the CO for transmission to the recipient's CPE device. Unfortunately, because voice transmissions generally require a smooth flow of information, the packets must be transmitted, received, and reassembled in substantially real-time. Many modern computer network protocols fail to consistently meet acceptable standards in this respect, resulting in packet loss and discard, often rendering voice communication choppy or delayed. What was needed was a network protocol which could guarantee the consistent real-time transmission of voice traffic.

In response to this need, the Telecommunications Standardization Sector of the International Telecommunication Union (ITU-T) and others have developed protocols (e.g., I.363.1 and I.366.2) for facilitating voice over ATM transmission using layers 1 and 2 of the ATM Adaptation Layer (AAL) model, as a technology capable of the high speed transfer of voice data across public packet-switched networks, such as the Internet. ATM utilizes very large-scale integration (VLSI) technology to segment data into individual packets having a fixed size of 53 bytes or octets. These packets are commonly referred to as cells. Unlike other types of networking protocols, ATM does not rely upon Time Division Multiplexing in order to establish the identification of each cell. That is, rather than identifying cells by their time position in a multiplexed data stream, ATM cells are identified solely based upon information contained within the cell header.

Further, ATM differs from system based upon conventional network architectures such as Ethernet or Token Ring in that rather than broadcasting data packets on a shared wire for all network members to receive, ATM cells dictate the successive recipient of the cell through information contained within the cell header. That is, a specific routing path through the network, called a virtual path (VP) or virtual circuit (VC), is set up between two end nodes before any data is transmitted. Cells identified with a particular virtual circuit are delivered to only those nodes on that virtual circuit. In this manner, only the destination identified in the cell header receives the transmitted cell. Further, this concept enables bandwidth to be specifically allocated to the VP or VC handling the voice communication.

The backbone of an ATM network consists of switching devices capable of handling the high-speed ATM cell streams. The switching components of these devices, commonly referred to as the switch fabric, perform the switching function required to implement a virtual circuit by receiving ATM cells from an input port, analyzing the information in the header of the incoming cells in real-time, and routing them to the appropriate destination port. Millions of cells per second are switched by a single device.

Importantly, this connection-oriented scheme permits an ATM network to guarantee the minimum amount of bandwidth required by each connection. Such guarantees are made when the connection is set-up. When a connection is requested, an analysis of existing connections is performed to determine if enough total bandwidth remains within the network to service the new connection at its requested capacity. If the necessary bandwidth is not available, the connection is refused.

In order to achieve efficient use of network resources, bandwidth is allocated to established connections under a statistical multiplexing scheme. Therefore, congestion conditions may occasionally occur within the ATM network resulting in cell transmission delay or even cell loss. To ensure that the burden of network congestion is placed upon those connections most able to handle it, ATM offers multiple grades of service, such as variable bit rate (VBR), real-time VBR, unspecified bit rate (UBR), and constant bit rate (CBR). These grades of service support various forms of traffic requiring different levels of cell loss probability, transmission delay, and transmission delay variance, commonly known as delay jitter. This system enables voice traffic to be prioritized over other, less time sensitive forms of data transmission.

Although significant advancements in Voice over ATM telephony and other forms of voice over packet-switched network technologies have been developed, significant improvements are required prior to the general adoption of this methodology. Accordingly, vendors and developers in this area must continually develop and test new applications for performing the functions required to transmit voice traffic acceptably over packet-switched networks. Unfortunately, this above described protocols, and the various software and hardware systems designed to implement them, conventionally require that a large portion of the data processing be performed at the CO location, thus resulting in an asymmetrical relay of information between parties. In this setting, all information relayed between a caller and a recipient must first be filtered through the CO. However, during design, testing and development, inclusion of a CO may be unnecessary, unavailable, expensive or even unacceptable, for confidentiality reasons. Further, it may desirable to simply carry out low-level testing to determine if the designed major hardware/software blocks work well together.

Accordingly, it is desired to provide a system and method for enabling customer devices to symmetrically transmit voice information between themselves without requiring intervention on the part of a CO.

### SUMMARY OF THE INVENTION

The present invention overcomes the above-described problems and deficiencies by providing a system and method for providing symmetrical connectivity between at least two consumer premises equipment (CPE) telecommunications devices is provided. At least two consumer premises equipment telecommunications devices are operatively connected over an asynchronous transfer mode telecommunications network. The at least two consumer premises equipment telecommunications devices are configured to perform local tone generation, local tone detection and decoding, and direct transfer and decoding of dialed digits using channel associated signaling (CAS) secondary service packets and dialed digit packets to transition between various states.

In accordance with one embodiment of the present invention, CAS packets include 8 bytes of information and dialed digit packets include 9 bytes of information. Further, signaling messages transported using the CAS packets preferably include the following: TALK, TEARDOWN, RINGING, BUSY, and ERROR. The above signaling messages as well as local events trigger transitions between various states including the following: ONHOOK, OFFHOOK, DIALTONE, RINGING, RINGBACK, and TALKING.

By providing symmetrical connectivity of CPE devices, central office involvement may be eliminated.

### BRIEF DESCRIPTION OF THE DRAWINGS

The present invention can be understood more completely by reading the following Detailed Description of the Preferred Embodiments, in conjunction with the following drawings.

FIG. 1 is a block diagram illustrating both conventional asymmetrical and inventive symmetrical telephony systems.

FIG. 2 is a flow chart describing one exemplary exchange of messages in a conventional telephony signaling scheme.

FIG. 3 is a block diagram illustrating the transitions between various system states.

FIG. 4 is a flow chart describing a method for setting up a voice call utilizing the signaling scheme of the present invention.

FIG. 5 is a flow chart describing a method for tearing down a voice call utilizing the signaling scheme of the present invention.

### DETAILED DESCRIPTION OF THE PREFERRED EMBODIMENTS

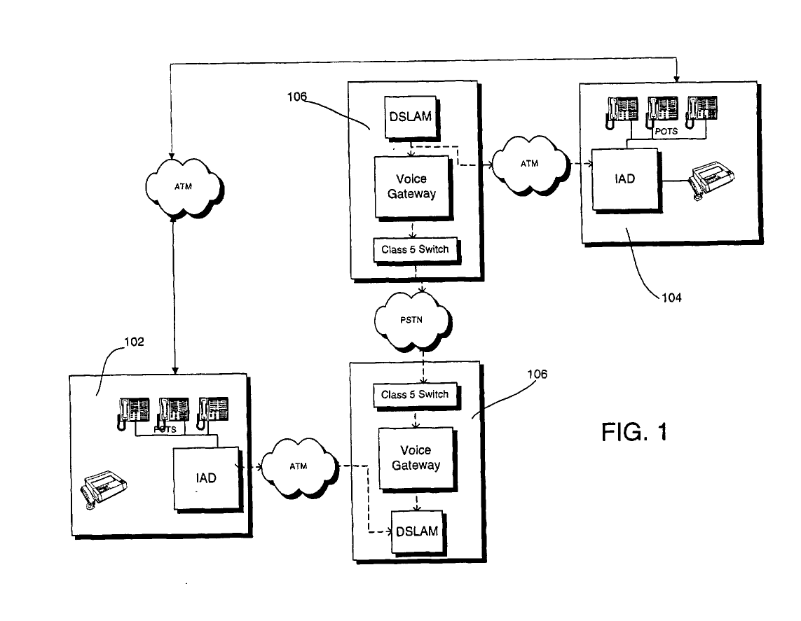

Referring generally to figures and, in particular, to FIG. 1, there is shown a block diagram 100 illustrating both a conventional asymmetrical packet-switched telephony system as well as one embodiment of the symmetrical packet-switched telephony system of the present invention, with dashed lines indicated convention systems and the solid line indicating the system of the present invention. In particular, diagram 100 includes a first CPE device 102 and a second CPE device 104. It should be understood that the CPE devices described herein may be or include any of the following: a telephone, a fax machine, a modem (e.g., digital subscriber line, coaxial cable, phone), private branch exchange (PBX), or any other integrated access device (IAD) for performing packetization of voice traffic and associated functionalities. In conventional packet-switched telephony systems, sending information from the first CPE device 102 to the second CPE device requires the intervention of at least one CO device 106. Typically, multiple CO devices are required in that the respective CPE devices operate in different locations and are controlled by respective CO devices.

In operation, CO device 106 is typically operated by an incumbent local exchange carrier (ILEC) and/or a competitive local exchange carrier (CLEC) and includes, for DSL networks, at least a DSL access multi-plexer (DSLAM), a voice gateway for receiving the packetized voice traffic and formatting it for reception by a class 5 voice switch, and a class 5 voice switch for delivering the formatted voice traffic onto the PSTN. As described in detail above, traditional packet-switched telephony signaling protocols/schemes are typically based on asymmetrical messages, taking place between one of the CPE devices 102/104 and the CO device 106. The purpose of these messages is to establish a (voice or analog data (e.g., fax)) connection between the caller and the callee. These messages are exchanged between the CPE and CO in order to notify each other that specific events have occurred.

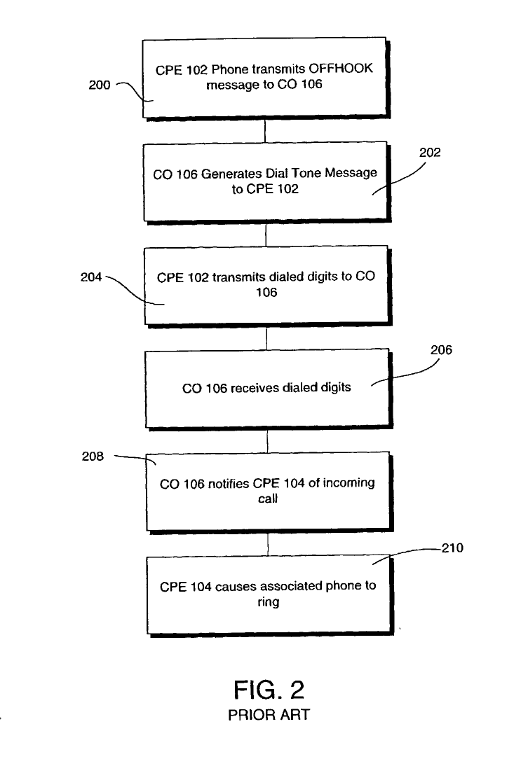

Referring now to FIG. 2, there is shown a flow chart describing one exemplary exchange of messages in a conventional packet-switched telephony signaling scheme. In step 200, a telephone goes offhook at CPE 102, and, correspondingly, CPE 102 notifies the CO 106 with a specific offhook message. Typically, this involves packetizing the message at the CPE 102's IAD, and relaying the packetized message through the CO's DSLAM, voice gateway, and onto the class 5 switch. In response, CO 106 typically generates, in-band, the traditional dial tone and relays it back to the CPE 102 in step 202. Conventionally, the dial tone is generated by the class 5 switch and relayed back through the network to CPE 102's IAD and onto the telephone which is offhook. In step 204, the CPE 102, in response to the user's input transmits dialed tones representative of CPE 104's telephone number to the class 5 switch in CO 106. In step 206, the CO 106 receives the dialed digits, and in step 208 notifies the CPE 104 of an incoming call. In response, in step 210 the CPE 104 causes an associated telephone to ring. A typical signaling scheme well established in the market between the CO class 5 switches and the PSTN is the GR-303 set of requirements established by Telcordia Technologies, Inc. GR-303 defines (for example for the Loop Start signaling type) specific state changes: loop open and loop closure on the CPE side; loop current feed open, loop current feed and ringing on the CO side. These states, triggered by specific events, are then mapped into specific signaling messages (for example using ABCD bits) which then get notified to the peer end, which reacts accordingly.

Unfortunately, the above disclosed signaling scheme does not work in back-to-back (i.e., direct CPE to CPE) scenarios because the functionality required to facilitate the communication is not present at the CPE side. In particular, in conventional systems, signaling messages are not symmetrical. That is, information is not passed back and forth between the caller and the callee. Rather, at least one intermediary CO is necessary to decipher and route the transmitted information. Further, tones, such as the dial tone, the engaged tone and the error tone, are traditionally generated by the CO in-band (and specifically, by the class 5 switch associated with the CO), rather than directly by the individual CPE devices involved in the call. Also, conventional CPE devices are provided with limited intelligence. In addition, dialed digits received during the call are conventionally not decoded by the CPE software affiliated with the receiving party. Rather, the CO performs the decoding functions and relays necessary information to the receiving CPE if recognized.

These problems can be overcome adopting the symmetrical signaling scheme of the present invention. As stated above, in circumstances where CO involvement is either unnecessary, unavailable, or overly expensive, it may be desirable to establish a communication directly between two (or more) CPE devices directly. Returning to FIG. 1, the inventive symmetrical signaling scheme removes the CO 106 from the information pathway between CPE 102 and CPE 104. In particular, as will be described in additional detail below, tones, such as the dial tone, are generated locally according to related state transitions, and an extended state machine is adopted. Further, dialed digits are transported between the CPE devices 102 and 104 using ITU-T I.366.2 dialed digits secondary service packets, simplifying the need in the digital signal processor to recognize tones (tone detection), and entirely delegating the host processor to handle the required state machine.

In one embodiment, the inventive symmetrical telephony signaling scheme is based on the following S signaling messages: TALK, TEARDOWN, RINGING, BUSY, and ERROR. In addition, the state machine implemented at each connected CPE device is composed of one of the following six states: ONHOOK; OFFHOOK; DIALTONE; RINGBACK; RINGING; and TALKING. The transition from one state to another is then triggered by receiving signaling messages from the connected CPE device, or triggered by local events at the individual CPE device, such as going ‘onhook’ or ‘offhook’ at the device itself.

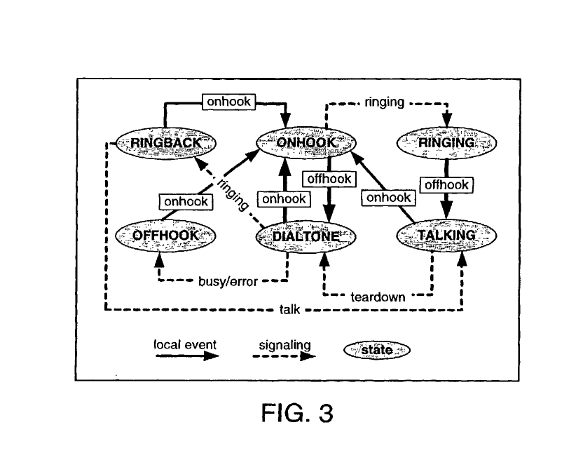

Turning now to FIG. 3, there is shown a block diagram illustrating the transitions between the various states described above. The illustrated transitions are triggered by local events (solid arrows) or signaling messages (dotted arrows). Signaling messages are transported using channel associated signaling (CAS) secondary service packets as generally defined in ITU-T I.366.2. However, in accordance with the present invention, the size of the transmitted CAS packets is increased from the standard 5 bytes to 8 bytes (3 additional bytes) in order to carry additional information required by the new signaling scheme. Further, dialed digit packets received in-band have also been extended in size from the conventional 6 bytes to 9 bytes in order to carry the additional information required. The additional information required include values relating to the channel ID in use and the connection ID of the call originator. The channel ID of the originator determines which channel ID will be used in establishing the channel. So the call originator acts as a master, in this respect. Additionally, the connection ID is needed when the peer end (callee) posts some messages (i.e. when it's gone ONHOOK) back to caller for some event notification.

Relating now to the particular information contained within each of the CAS signaling packets, the initial 5 bytes contain information identical to that contained within traditional CAS packets formed in accordance with the ITU-T I.366.2 functional specification. However, in accordance with the present invention, the extra 3 bytes referenced above contain different information according to what kind of event they are triggered. In the conventional manner, bytes 1-5 contained the following information: byte 1: redundancy[8-7] timestamp[6-1]; byte 2: timestamp[8-1]; byte 3: reserved[8-5],A bit[4],B bit[3],C bit[2],D bit[1]; byte 4: message type[8-3],crc10[2-1]; byte 5: crc10[8-1].

After the standard first 5 bytes definitions, the content of bytes 6-8 are defined by the events which result in the packet generation and transmission. The following include examples of CAS packet formation for several specific events. In particular, where the event is either a CPE telephone transition from the TALKING state to the ONHOOK state or from a RINGBACK state to an ONHOOK state, byte 6 of the CAS packet includes a peer CPE ID value; byte 7 includes a value representative of the AAL2 CPS CID (channel ID) currently in use; and byte 8 is unused.

For dialed digit packets, the six bytes are again identical to conventional ITU-T I.366.2 packets, with byte 1 relating to redundancy[8-7] and timestamp[6-1]; byte 2 relating to timestamp[8-1]; byte 3 relating to reserved[8-6] and signal level[5-1]; byte 4 relating to digit type[8-6] and digit code[5-1]; byte S relating to message type[8-3], and crc10[2-1]; and byte 6 relating to crc10[8-1]. However, as referenced above, additional bytes 7-9 are configured to include additional information relating channel and connection ID values. In particular, byte 7 relates specifically to the CPE id of the “sender”; byte 8 relates to the AAL2 CPS CID (channel ID) to be used; and byte 9 is unused (set to 0) and is only required as a packet size discriminator. By providing this additional information in the CAS signaling message packets and the dialed digit packets, peer CPE devices are able to responde to received signals in an appropriate manner.

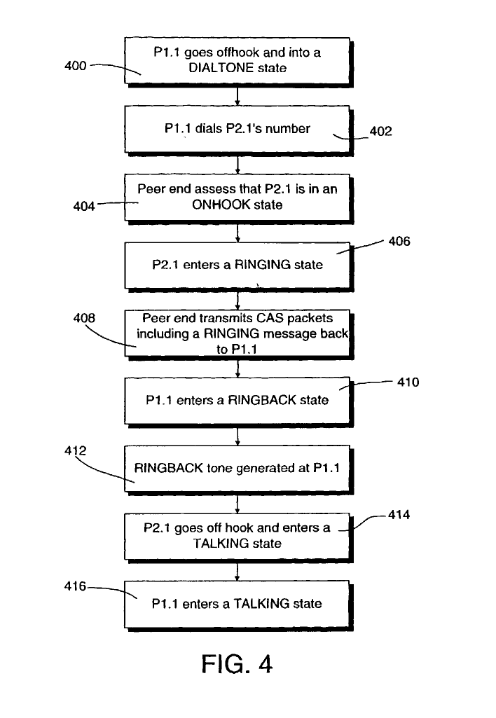

Referring now to FIG. 4, there is shown a flow chart describing a method for setting up a voice call utilizing the signaling scheme of the present invention. For description purposes, the system used in performing the described method should be understood to include two CPE devices, each having 3 telephones/handsets already connected and initialized. On each board, the first telephone has a connection ID 0 and channel ID 16, the second telephone has a connection ID 1 and channel ID 17 and the third telephone has a connection ID 2 and channel ID 18. To further simplify the description, it should be understood that Px.y is shorthand for board X, telephone Y (i.e., P1.2 means telephone 2 of board 1).

In step 400, P1.1 goes offhook and goes into DIALTONE state, wherein the dial tone is locally generated by the CPE device. In step 402, P1.1 dials the number belonging to P2.1, and the dial tone is stopped, wherein each dialed number is transmitted to the peer end as a dialed digit packet. In step 404, the peer end assesses that P2.1 is in an ONHOOK state, so accordingly, in step 406, sets P2.1 into a RINGING state and makes it ringing. In step 408, the peer end sets the correct channel parameters (i.e. which channel ID to use), then transmits a CAS packet including a RINGING message back to P1.1. Upon reception of the RINGING message, P1.1 goes into a RINGBACK state in step 410 and, in step 412, a ring back tone is locally generated. When P2.1 is answered, it goes off hook, and because it was in a RINGING state, its state changes into a TALKING state in step 414. At this point a CAS packet with a TALK message is transmitted to P1.1 in step 416. In response, P1.1 likewise enters a TALKING state. Due to the symmetrical nature of the inventive signaling system, no CO device is required to enable the transmission of information between P1.1 and P2.1.

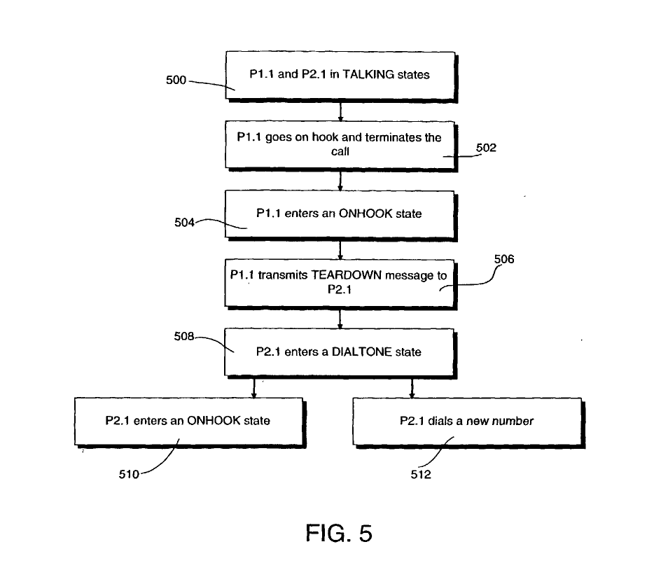

Referring now to FIG. 5, there is shown a flow chart describing a method for tearing down a voice call utilizing the signaling scheme of the present invention. In step 500, it is assumed that P1.1 and P2.1 are connected to each other and voice traffic is exchanged between them. In step 502, P1.1 goes on hook and terminates the voice call. Accordingly, P1.1 changes into an ONHOOK state in step 504. In response, P1.1 transmits a CAS packet including a TEARDOWN message to P2.1 in step 506. Upon reception of the TEARDOWN message, P2.1 goes into a DIALTONE state in step 508, and a dial tone is locally generated. At this stage, P2.1 may choose to go on hook, with the state changing into an ONHOOK state in step 510, or it can dial a new number in step 512.

In summary, the proposed telephony signaling protocol is characterized by complete symmetry and simplicity based on a simple state machine and message set; flexibility, because it does not impose limits in terms of how many handsets can be supported; and robustness, exploiting triple redundancy and packet refresh features of I.366.2, and reducing the likelihood of messages getting lost or discarded.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A system for providing symmetrical connectivity between at least two consumer premises equipment telecommunications devices, comprising:
at least two consumer premises equipment telecommunications devices operatively connected over an asynchronous transfer mode telecommunications network,
wherein the at least two consumer premises equipment telecommunications devices are configured to perform local tone generation, local tone detection and decoding, and direct transfer and decoding of dialed digits.

2. The system of claim 1, wherein the at least two consumer premises equipment telecommunications devices are further configured to generate, exchange and decode state transition signaling messages.

3. The system of claim 2, wherein the state transition signaling messages are transported using channel associated signaling secondary service packets.

4. The system of claim 3, wherein the channel associated signaling secondary service packets comprise 8 bytes of information.

5. The system of claim 3, wherein the channel associated signaling secondary service packets include a channel identification value and a connection identification value.

6. The system of claim 1, wherein the at least two consumer premises equipment telecommunications devices are further configured to generate, exchange and decode dialed digit packets, wherein the dialed digit packets represent numbers dialed on at least one of the consumer premises equipment telecommunications devices.

7. The system of claim 6, wherein the dialed digit packets comprise 9 bytes of information.

8. The system of claim 6, wherein the dialed digit packets include a channel identification value and a connection identification value.

9. The system of claim 1, wherein each of the at least two consumer premises equipment telecommunications devices further comprise a state machine for transitioning each of the at least two consumer premises equipment telecommunications devices into a plurality of operational states triggered by a plurality of events.

10. The system of claim 9, wherein the plurality of operational states include an ONHOOK state, an OFFHOOK state; a DIALTONE state, a RINGING state, a RINGBACK state, and a TALKING state.

11. The system of claim 9, wherein the plurality of events include local events and a plurality of signaling messages from another of the at least two consumer premises equipment telecommunications devices.

12. The system of claim 11, wherein local events include going onhook and going offhook.

13. The system of claim 11, wherein the plurality of signaling messages include a TALK message, a TEARDOWN message, a RINGING message, a BUSY message, and an ERROR message.

14. A method for providing symmetrical connectivity between at least two consumer premises equipment telecommunications devices, comprising the steps of:
operatively connected at least two consumer premises equipment telecommunications devices over an asynchronous transfer mode telecommunications network;
configuring the at least two consumer premises equipment telecommunications devices are to perform local tone generation;
configuring the at least two consumer premises equipment telecommunications devices are to perform local tone detection and decoding; and
configuring the at least two consumer premises equipment telecommunications devices are to perform direct transfer and decoding of dialed digits.

15. The method of claim 14, further comprising the step of configuring the at least two consumer premises equipment telecommunications devices to generate, exchange and decode state transition signaling messages.

16. The method of claim 15, further comprising the step of transporting the state transition signaling messages are using channel associated signaling secondary service packets.

17. The method of claim 16, wherein the channel associated signaling secondary service packets comprise 8 bytes of information.

18. The method of claim 16, wherein the channel associated signaling secondary service packets include a channel identification value and a connection identification value.

19. The method of claim 14, further comprising the step of configuring the at least two consumer premises equipment telecommunications devices to generate, exchange and decode dialed digit packets, wherein the dialed digit packets represent numbers dialed on at least one of the consumer premises equipment telecommunications devices.

20. The method of claim 19, wherein the dialed digit packets comprise 9 bytes of information.

21. The method of claim 20, wherein the dialed digit packets include a channel identification value and a connection identification value.

22. The method of claim 14, further comprising the step of transitioning each of the at least two consumer premises equipment telecommunications devices into a plurality of operational states triggered by a plurality of events.

23. The method of claim 22, wherein the plurality of operational states include an ONHOOK state, an OFFHOOK state; a DIALTONE state, a RINGING state, a RINGBACK state, and a TALKING state.

24. The system of claim 23, wherein the plurality of events include local events and a plurality of signaling messages from another of the at least two consumer premises equipment telecommunications devices.

25. The method of claim 24, wherein local events include going onhook and going offhook.

26. The method of claim 25, wherein the plurality of signaling messages include a TALK message, a TEARDOWN message, a RINGING message, a BUSY message, and an ERROR message.

27. The method of claim 26, further comprising the steps of:
transitioning the at least two consumer premises equipment telecommunications devices from the ONHOOK state into the DIALTONE state upon the occurrence of the going offhook local event;
transitioning the at least two consumer premises equipment telecommunications devices from the DIALTONE state into the ONHOOK state upon the occurrence of the going onhook local event;
transitioning the at least two consumer premises equipment telecommunications devices from the OFHOOK state into the ONHOOK state upon the occurrence of the going onhook local event;
transitioning the at least two consumer premises equipment telecommunications devices from the RINGBACK state into the ONHOOK state upon the occurrence of the going onhook local event;
transitioning the at least two consumer premises equipment telecommunications devices from the TALKING state into the ONHOOK state upon the occurrence of the going onhook local event;
transitioning the at least two consumer premises equipment telecommunications devices from the ONHOOK state into the RINGING state upon the receipt of dialed digit packets corresponding to the respective consumer premises equipment telecommunications device;
transitioning the at least two consumer premises equipment telecommunications devices from the DIALTONE state into the OFFHOOK state upon receipt of the occurrence of the BUSY signaling message;
transitioning the at least two consumer premises equipment telecommunications devices from the DIALTONE state into the OFFHOOK state upon receipt of the occurrence of the ERROR signaling message;
transitioning the at least two consumer premises equipment telecommunications devices from the DIALTONE state into the RINGBACK state upon receipt of a RINGING signaling message;
transitioning the at least two consumer premises equipment telecommunications devices from the RINGBACK state into the TALKING state upon the receipt of a TALK signaling message; and
transitioning the at least two consumer premises equipment telecommunications devices from the TALKING state into the DIALTONE state upon receipt of the occurrence of the TEARDOWN signaling message.

28. A method for providing symmetrical connectivity between at least two consumer premises equipment telecommunications devices, comprising the steps of:
receiving, at a first consumer premises equipment telecommunications device, a going offhook local event;
transitioning the first consumer premises equipment telecommunications device into a DIALTONE state;
transmitting dialed digit packets representative of the second consumer premises equipment telecommunications device from the first consumer premises equipment telecommunications device to a second consumer premises equipment telecommunications device operatively connected to the first consumer premises equipment telecommunications device; and
determining whether the second consumer premises equipment telecommunications device is in an ONHOOK state.

29. The method of claim 28, further comprising the steps of if it is determined that the second consumer premises equipment telecommunications device is in the ONHOOK state:
transitioning the second consumer premises equipment telecommunications device into a RINGING state;
generating a RINGING tone at the second consumer premises equipment telecommunications device;
transmitting a RINGING signaling message from the second consumer premises equipment telecommunications device to the first consumer premises equipment telecommunications device;
transitioning the first consumer premises equipment telecommunications device into a RINGBACK state;
generating a RINGBACK tone at the first consumer premises equipment telecommunications device;
receiving, at the second consumer premises equipment telecommunications device, a going offhook local event;
transitioning the second consumer premises equipment telecommunications device into a TALKING state;
transmitting a TALK signaling message from the second consumer premises equipment telecommunications device to the first consumer premises equipment telecommunications device; and
transitioning the first consumer premises equipment telecommunications device into a TALKING state.

30. The method of claim 29, further comprising the steps of:
receiving a local going onhook event at the first consumer premises equipment telecommunications device;
transitioning the first consumer premises equipment telecommunications device into the ONHOOK state;
transmitting a TEARDOWN signaling message from the first consumer premises equipment telecommunications device to the second consumer premises equipment telecommunications device; and
transitioning the second consumer premises equipment telecommunications device into the DIALTONE state.

31. The method of claim 28, further comprising the steps of if it is determined that the second consumer premises equipment telecommunications device is not in the ONHOOK state:
transmitting a BUSY signaling message from the second consumer premises equipment telecommunications device to the first consumer premises equipment telecommunications device; and
transitioning the first consumer premises equipment telecommunications device into an OFFHOOK state.
